(19) United States
(12) Patent Application Publication
(10) Pub. No.: US 2009/0169007 A1
(43) Pub. Date: Jul. 2, 2009

(54) Control Area Network Data Encryption System and Method

(75) Inventor: Shawn R. Vasicheck, Fargo, ND (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: CLARK EQUIPMENT COMPANY, West Fargo, ND (US)

(21) Appl. No.: 12/342,905

(22) Filed: Dec. 23, 2008

Related U.S. Application Data
(60) Provisional application No. 61/017,931, filed on Dec. 31, 2007.

(51) Int. Cl. H04K 1/00

(52) U.S. Cl. 380/255

(57) ABSTRACT

A power machine is configured to carry an attachment which is detachably coupleable to the power machine. The power machine includes a supporting frame with an operating compartment from which an operator operates the power machine to actuate one or more actuators of the power machine. A sensing unit senses a change in an operating device of the power machine and generates data indicative of the change. A first controlling unit, positioned on and coupled to the power machine, receives the data from the sensing unit indicative of the change in the operating device, and generates in response a set of corresponding operating messages. An encryption module positioned on and coupled to the power machine uses a key to encrypt at least a first portion of the set of operating messages into encrypted messages. A first control-area-network (CAN) controller formats the encrypted messages into a CAN format, and the encrypted messages in the CAN format are transmitted over a CAN bus. At an attachment, the encrypted messages are received from the CAN bus, decrypted using the key, and used by a second controlling unit to execute instructions or acts.

### BACKGROUND

Embodiments of the invention generally relate to power machines, and more specifically, to a communication system for use with power machines.

Power machines, such as skid steer loaders, typically include a machine controller that controls tools attached to the power machines. The tools may include a tool controller. In some cases, the tool controller communicates with the machine controller via a control-area-network (“CAN”) bus network. However, unauthorized devices may also be attached to the CAN bus network, and may gain access and control to the power machines.

### SUMMARY

Power machines can have a frame to support a compartment and a movable arm to support an attachment such as a bucket. The movable arm is generally pivotally coupled to the frame with actuators such as hydraulic cylinders. When an operator operates a power machine, the operator actuates the actuators. In response to the actuated actuators, the movable arm moves.

When the operator causes the actuators to actuate, commands are sent from a controller in the power machine to the attachment. The commands are generally signals that conform to some communication protocols. To securely operate a power machine, the power machine provides a communication system for the power machine that encrypts CAN messages generated by a controller on the power machine and sends the encrypted CAN messages to a controller of an attachment. Particularly, the system also includes a software key that is configurable to encrypt and decrypt respective CAN messages.

In another embodiment, the invention provides a communication system for use with a power machine and an attachment detachably coupled to the power machine. The system includes a first control unit, a control-area-network (“CAN”) bus, and a second control unit. The first control unit is coupled to the power machine, generates operating messages, and has a first encryption and decryption module to receive a key, and to encrypt at least a first portion of the operating messages with the key. The control-area-network is coupled to the first control unit, and configured to carry the at least first portion of the encrypted operating messages. The second control unit is positioned in the attachment, and coupled to the control area network. The second control unit receives the at least first portion of the encrypted operating messages, and has a second encryption and decryption module to receive the at least first portion of the encrypted operating messages, to receive the key, and to decrypt the received portion of the encrypted operating messages with the key.

In another embodiment, the invention provides a method of communication for use with a power machine and an attachment detachably coupled to the power machine. The method includes generating an operating message at the power machine, and encrypting at least a first portion of the operating message with a key. The method also includes formatting the at least first portion of operating message into a control-area-network format, and transmitting the at least first portion of the formatted operating message to the attachment through a bus. The method also includes receiving the at least first portion of the formatted operating message via the bus, and decrypting the received portion of encrypted operating message with the key at the attachment.

In another embodiment the invention provides a power machine that includes a frame, a compartment supported by the frame, and first and second devices. The first device is positioned at one of the compartment and the attachment to generate operating instructions. The second device is coupled to the other of the compartment and the attachment to operate in response to the operating instructions. The first controlling unit is positioned at the first device, receives the operating instructions and a first key, encrypts at least a portion of the operating instructions into an encrypted message with the first key, and transmits the encrypted message to the second device. The second controlling unit is positioned at the second device, and receives the encrypted message and a second key, decrypts the received message, and controls the second device based at least in part on the decrypted message.

Other aspects of the invention will become apparent by consideration of the detailed description and accompanying drawings.

### BRIEF DESCRIPTION OF THE DRAWINGS

FIG. 1 is a side view of a power machine.

FIG. 2 is a block diagram of a communication system for use with the power machine of FIG. 1.

FIG. 3 is a flow diagram illustrating a full power machine message encryption process.

FIG. 4 is a flow diagram illustrating a partial power machine message encryption process.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models of what actual systems might be like. As noted, many of the modules and logical structures described are capable of being implemented in software executed by a microprocessor or a similar device or of being implemented in hardware using a variety of components including, for example, application specific integrated circuits (“ASICs”). Terms like “processor” may include or refer to both hardware and/or software. Furthermore, throughout the specification capitalized terms are used. Such terms are used to conform to common practices and to help correlate the description with the coding examples and drawings. However, no specific meaning is implied or should be inferred simply due to the use of capitalization. Thus, the claims should not be limited to the specific examples or terminology or to any specific hardware or software implementation or combination of software or hardware.

Furthermore, although the illustrated embodiment contemplates application of the invention to a skid loader, the invention may be applied to substantially any power machine.

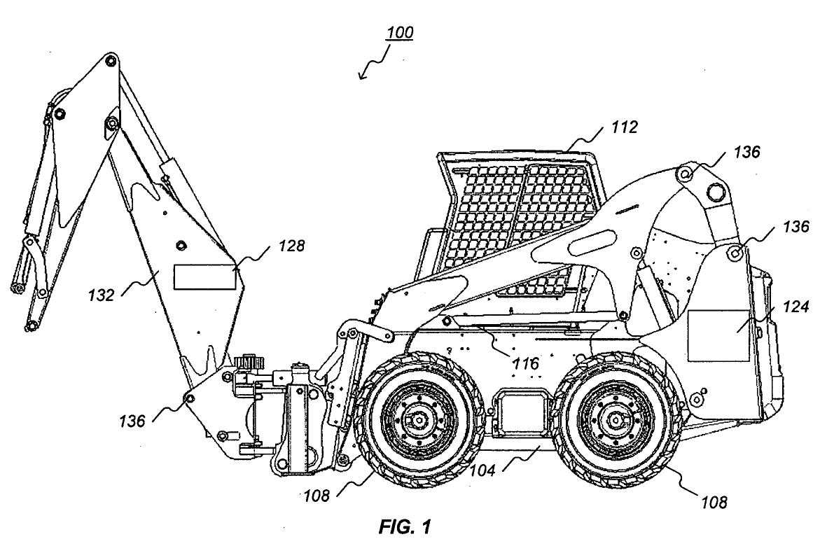

FIG. 1 is a side view of a power machine 100 such as a skid loader. The power machine 100 includes a supporting frame or main frame 104 and wheels 108 to drive the power machine 100 with an internal combustion engine. The supporting frame 104 also includes an operator compartment 112 in which an operator operates the power machine 100. The operator compartment 112 typically includes a seat, a seat bar, and operating devices such as a hand grip or joystick, instrument cluster, instrument displays, other display panels, other input panels, levers, foot pedals, and the like. For example, an operator can maneuver the joystick in a certain way, which in turn, actuates one or more actuators 116, such as hydraulic cylinders. Although one actuator 116 is shown, it should be understood that the power machine 100 includes other actuators. It is also noted that, in some cases, an operator can operate the power machine 100 remotely and/or wirelessly.

Particularly, when an operator moves the operating devices such as a hand grip, sensors of the operating device generates a plurality of data indicative of a movement or a change in parameter of the operating devices. A host-processor or host-controller in a controlling unit 124 of the power machine 100 or of the operating device receives the data, and generates a set of corresponding operating or actuating instructions or messages. A control-area-network (“CAN”) controller receives the messages, encrypts the messages, formats the encrypted messages into a CAN format, and transmits the formatted messages through a CAN bus serially, detailed hereinafter. Although the illustrated embodiment shows a generic location of the controlling unit 124, it should be noted that the controlling unit 124 can be located in other locations of the power machine 100. Furthermore, each of the operating devices can include a host-processor that communicates with a corresponding host-CAN controller. In other embodiments, the host-controller encrypts the messages, and transmits the encrypted messages to the CAN controller for further processing as discussed.

A second controlling unit 128 receives the formatted messages through a CAN bus. Particularly, a transceiver receives the messages, and transmits the received messages to a corresponding CAN controller. The CAN controller then reformats, decrypts, and transmits the received messages to a second host-controller. The second host-controller then actuates devices in response to the messages from the CAN controller. As discussed earlier, the CAN controller can receive and re-transmit the received messages to the second host-controller for further processing such as decryption. After the second controlling unit 128 has received some operating instructions, the second controlling unit 128 actuates a corresponding device, such as a movable lift arm 132 that is pivotally coupled to the supporting frame 104 at pivot points 136. The movable lift arm 132 then moves an attachment in response to the received messages. Other exemplary corresponding devices include attachments, such as a bucket, the actuators 116, and the like. Communications between the first and second controlling units 124, 128 are generally bi-directional. For example, the second controlling unit 128 can also transmit encrypted CAN messages to the first controlling unit 124.

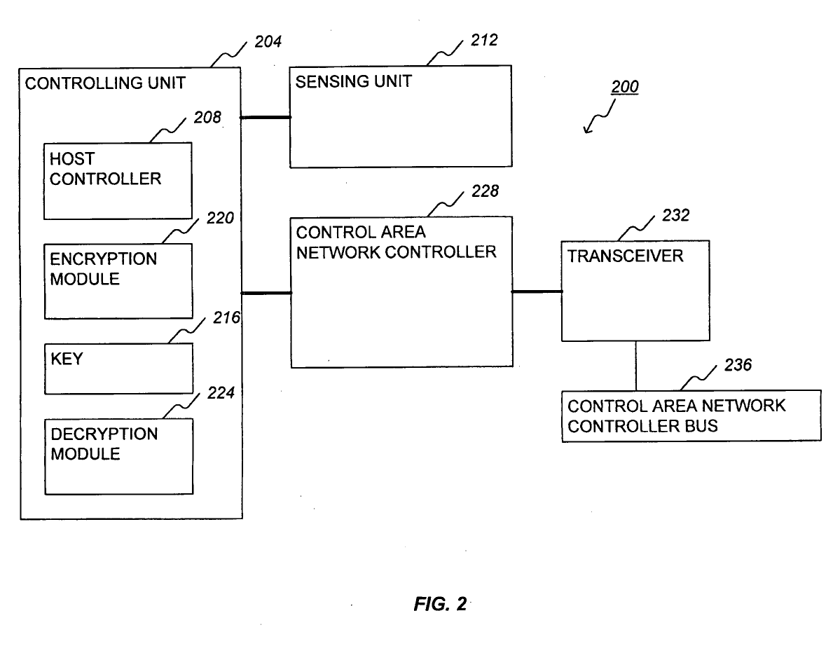

FIG. 2 is a block diagram of a communication system or electronic control unit (“ECU”) 200 for use with the power machine 100 of FIG. 1, wherein like numerals refer to like parts. The ECU 200 includes a generic controlling unit 204 (such as 124, or 128 of FIG. 1) that further includes a host controller 208. The controlling unit 204 receives data from a sensing subsystem 212. In some embodiments, the sensed data includes data indicative of movements of an operating device such as a joystick, or an activation of a button on a panel, for example. Based on a key 216 stored or received at the controlling unit 204, an encryption module 220 or a decryption module 224 encrypts or decrypts a message received. The key is generally software configurable. In some embodiments, for example, an operator will be prompted to enter a key, to enter in a password which activates the key, or to insert a removable device, such as a thumb drive that contains the key and/or the encryption/decryption algorithm, such that the key and/or the encryption/decryption algorithm can be transmitted to the ECU 200 for encrypting and/or decrypting messages. Although the encryption and decryption modules 220, 224 are shown as an individual module, the encryption and decryption modules 220, 224 can also be implemented as a single module. In some embodiments, the encryption and decryption modules 220, 224 are firmware, hardware, and/or software modules of the host controller 208. That is, the host-controller 208 can also encrypt and/or decrypt messages based on the key and the encryption and decryption modules 220, 224 therein.

In cases where messages are received at the decryption module 224, the decryption module 224 decrypts the received message based on the key. Once decrypted, the decryption module 224 sends the decrypted message to the host controller 208. In turn, the host controller 208 executes instructions or acts based on the decrypted message. As such, messages that are not encrypted with the key will not be acted upon. In this way, the key provides an additional security function.

In cases where messages are received at the encryption module 220, the encryption module 220 encrypts the movement data with the key provided for further processing. For example, the host controller 208 uses the key 216 to encrypt messages received from the sensing unit 212. A CAN controller 228 subsequently formats the encrypted data in an appropriate CAN format for transmission with a transceiver 232 and a CAN bus 236. In some embodiments, encryption and decryption are implemented with a pretty good privacy (“PGP”) cryptographic and authentication, or similar algorithms. It should be noted that other encryption and decryption algorithms can also be used. Furthermore, in some embodiments, only one of the encryption module 220 and the decryption module 224 is active or enabled at a time. In other embodiments, either one or both of the encryption module 220 and the decryption module 224 can be globally enabled and disabled with a service tool to allow message monitoring during experiments and development.

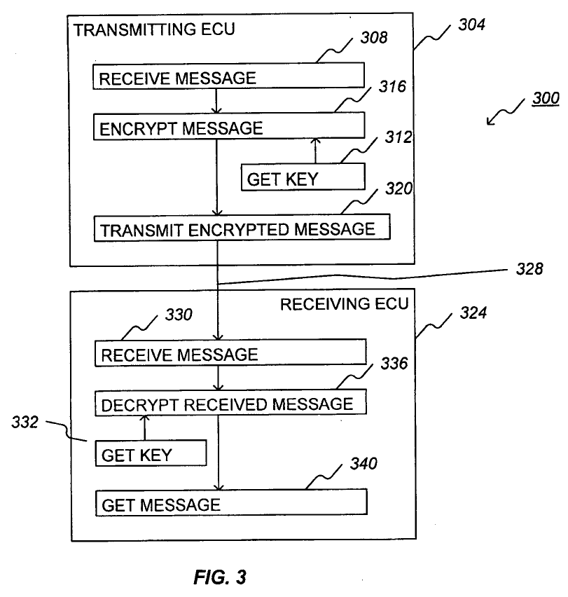

FIG. 3 is a flow diagram illustrating a full power machine message encryption process 300, wherein like numerals refer to like parts. In the full power machine message encryption process 300, a transmitting ECU 304 (such as ECU 200) receives a message, which includes all bits that require encryption, at block 308. Once a key is received at block 312, the encryption module 220 uses an encryption program or algorithm to encrypt the message at block 316. The full power machine message encryption process 300 then formats the encrypted data with the CAN controller 228 (of FIG. 2), and transmits the encrypted data at block 320 through the transceiver 232 (of FIG. 2) to a receiving ECU 324 (such as ECU 200 of FIG. 2) through a CAN bus 328 (236 of FIG. 2). Once received with the transceiver 232 (of FIG. 2) at block 330, the receiving ECU 324 determines if a decrypting key is available at block 332. When a decrypting key is available at block 332, the receiving ECU 324 decrypts the received message at block 336 with the decrypting key, the decryption module 224 (of FIG. 2), and a decryption algorithm, and generates a decrypted message at block 340. The decrypted message can include operating instructions that actuate the actuators 116 (of FIG. 1), for example.

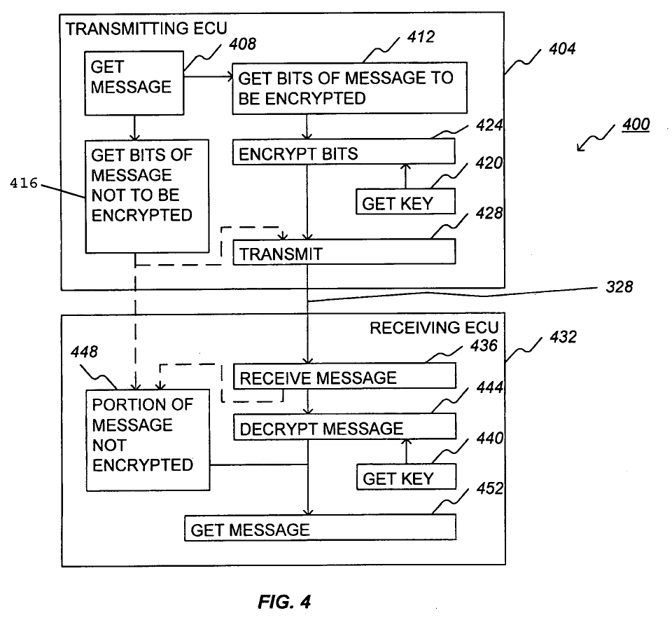

FIG. 4 is a flow diagram illustrating a partial power machine message encryption process 400, wherein like numerals refer to like parts. In the partial power machine message encryption process 400, a second transmitting ECU 404 (such as ECU 200 of FIG. 2) receives a message, includes a number of bits that require encryption and a number of bits that do not require encryption, at block 408. The partial power machine message encryption process 400 separates the number of bits that require encryption and the number of bits that do not require encryption from the message at blocks 412 and 416, respectively.

Once a key is received at block 420, the partial power machine message encryption process 400 uses an encryption program or algorithm to encrypt the number of bits that require encryption at block 424. The partial power machine message encryption process 400 then formats the encrypted data with the CAN controller 228 (of FIG. 2), and transmits the encrypted data at block 428 through the transceiver 232 (of FIG. 2) to a second receiving ECU 432 (such as ECU 200 of FIG. 2) through the CAN bus 328 (236 of FIG. 2).

Once received at the transceiver 232 (of FIG. 2) at block 436, the second receiving ECU 432 determines if a decrypting key is available at block 440. When a decrypting key is available at block 440, the partial power machine message encryption process 400 decrypts the received message at block 444 with the decrypting key, the decryption module 224 (of FIG. 2), and a decryption algorithm, and generates a decrypted message. The partial power machine message encryption process 400 also receives the bits that do not require encryption at block 448, the bits that do not require encryption are combined with the decrypted message, which results in a message at block 452 that can include operating instructions that actuate the actuators 116 (of FIG. 1), for example. It should be noted that, although not explicitly shown, the transceiver 232 (of FIG. 2) can also transmit the bits that do not require encryption at block 416 through the bus 328 to block 448. Other methods of transmission can also be used to transmit the bits that do not require encryption at block 416 to block 448.

In one exemplary message format, the message format is a 128 bit J1939 CAN 2.0B format. Other CAN data format or data structures, such as ISO 11898-2, ISO 11898-3, ISO 11992-1, ISO 11783-2, and the like, can also be used.

What is claimed is:

1. A power machine configured to carry an attachment which is detachably coupleable to the power machine, the power machine comprising:
a supporting frame including an operating compartment from which an operator operates the power machine to actuate one or more actuators of the power machine;
a sensing unit which senses a change in an operating device of the power machine and generates data indicative of the change;
a first controlling unit positioned on and coupled to the power machine, the first control unit receiving the data from the sensing unit indicative of the change in the operating device and generating in response a set of corresponding operating messages;
an encryption module positioned on and coupled to the power machine, the encryption module configured to use a key to encrypt at least a first portion of the set of operating messages into encrypted messages;
a first control-area-network (CAN) controller which formats the encrypted messages into a CAN format; and
a CAN bus over which the encrypted messages in the CAN format are transmitted.

2. The power machine of claim 1, and further comprising:
a second CAN controller which receives the encrypted messages in the CAN format and reformats the encrypted message out of the CAN format;
a decryption module configured to use the key to decrypt the encrypted messages to obtain the at least first portion of the set of operating messages; and
a second controlling unit coupled to the decryption module which executes instructions or acts based on the decrypted at least first portion of the set of operating messages.

3. The power machine of claim 2, wherein the second CAN controller, the decryption module and the second controlling unit are positioned on and supported by the attachment.

4. The power machine of claim 2, wherein the second CAN controller is configured to provide the decryption module.

5. The power machine of claim 2, wherein the second controlling unit is configured to provide the decryption module.

6. The power machine of claim 2, and further comprising:
a first transceiver coupled between the first CAN controller and the CAN bus, the first transceiver transmitting the CAN format encrypted messages over the CAN bus; and
a second transceiver coupled between the CAN bus and the second CAN controller, the second transceiver receiving the CAN format encrypted messages from the CAN bus.

7. The power machine of claim 1, wherein the encryption module is configured to use the key to encrypt the at least first portion of the set of operating messages into the encrypted messages, while a second portion of the set of operating messages is transmitted over the CAN bus without encryption.

8. The power machine of claim 1, wherein the first controlling unit is configured to provide the encryption module.

9. The power machine of claim 1, wherein the first CAN controller is configured to provide the encryption module.

10. A power machine communication system, the power machine configured to carry an attachment which is detachably coupleable to the power machine, the power machine communication system comprising:
a sensing unit on the power machine which senses a change in an operating device of the power machine and generates data indicative of the change;
a first controlling unit positioned on and coupled to the power machine, the first control unit receiving the data from the sensing unit indicative of the change in the operating device and generating in response a set of corresponding operating messages;
an encryption module configured to use a key to encrypt at least a first portion of the set of operating messages into encrypted messages;
a first control-area-network (CAN) controller which formats the encrypted messages into a CAN format;
a CAN bus over which the encrypted messages in the CAN format are transmitted;
a second CAN controller which receives the encrypted messages in the CAN format and reformats the encrypted message out of the CAN format;
a decryption module configured to use the key to decrypt the encrypted messages to obtain the at least first portion of the set of operating messages; and
a second controlling unit coupled to the decryption module which executes instructions or acts based on the decrypted at least first portion of the set of operating messages.

11. The power machine communication system of claim 10, wherein the first controlling unit is configured to provide the encryption module.

12. The power machine communication system of claim 10, wherein the first CAN controller is configured to provide the encryption module.

13. The power machine communication system of claim 10, wherein the second CAN controller is configured to provide the decryption module.

14. The power machine communication system of claim 10, wherein the second controlling unit is configured to provide the decryption module.

15. The power machine communication system of claim 10, and further comprising:
a first transceiver coupled between the first CAN controller and the CAN bus, the first transceiver transmitting the CAN format encrypted messages over the CAN bus; and
a second transceiver coupled between the CAN bus and the second CAN controller, the second transceiver receiving the CAN format encrypted messages from the CAN bus.

16. The power machine communication system of claim 10, wherein the encryption module is configured to use the key to encrypt the at least first portion of the set of operating messages into the encrypted messages, while a second portion of the set of operating messages is transmitted over the CAN bus without encryption.
